(19) United States
(12) Patent Application Publication
(10) Pub. No.: US 2024/0135215 A1
(43) Pub. Date: Apr. 25, 2024

(54) PRODUCTION TO STAGING ISOLATION ZONE CREATION

(71) Applicant: Red Hat, Inc., Raleigh, NC (US)

(72) Inventors: Leigh Griffin, Waterford (IE); Stephen Coady, Waterford (IE)

(21) Appl. No.: 17/971,788

(22) Filed: Oct. 23, 2022

(51) Int. Cl. G06N 10/20

(52) U.S. Cl. CPC G06N 10/20

(57) ABSTRACT

Processing logic may analyze a quantum environment to determine one or more properties of the quantum environment. Processing logic may analyze a quantum program to determine one or more requirements of the quantum program. Processing logic may generate a quantum isolation zone in view of the one or more properties and the one or more requirements, to resemble the quantum environment. Processing logic may run the quantum program within the quantum isolation zone.

### TECHNICAL FIELD

Aspects of the present disclosure relate to computer systems, and more particularly, to creating a quantum isolation zone for testing a quantum program.

### BACKGROUND

Computing devices may execute instructions that are grouped together as a computer program to perform one or more related actions. Computing devices may be communicatively coupled to each other over a network, which may include electrical or optical wiring, wireless radio-frequency transceivers, or other network infrastructure. The computing devices may communicate with each other over the network, using a variety of communication protocols.

Quantum computing, or computing devices that implement quantum computing (e.g., quantum computers), utilize principles of quantum theory such as superposition and entanglement. Classical computers process data that is encoded as binary bits that are limited to being in one of two definite states (“0” or “1”). Quantum computers process data in units of quantum bits (qubits) that can be in superpositions of states. Quantum computing can potentially solve problems with far greater speed than traditional computers.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 shows an example of a quantum computing system, in accordance with some embodiments.

FIG. 2 shows a block diagram of an example computing device that may use a quantum isolation zone for staging of a quantum program, in accordance with some embodiments.

FIG. 3 illustrates an example workflow for testing of a quantum program, in accordance with some embodiments.

FIG. 4 illustrates an example method for testing of a quantum program with a quantum isolation zone, in accordance with some embodiments.

FIG. 5 is a block diagram of an example quantum computing device that may perform one or more of the operations described herein, in accordance with some embodiments.

### DETAILED DESCRIPTION

Traditional computers typically employ a stream of electrical impulses (1 and 0) in a binary manner to encode information in bits. This restricts their processing ability, compared to quantum computing.

In quantum computing, a number of elemental particles such as electrons or photons can be used to represent data or facilitate computation. Each particle (e.g., a qubit) may be given a charge, or polarization, acting as a representation of 0 or 1 or both (e.g., a superposition of 0 and 1).

A variety of different qubit technology exists. For example, a qubit may be formed by the polarizations of a photon, discrete energy levels of an ion, a superconducting Transmon qubit, the nuclear spin states of an atom, the spin states of an electron, etc. Qubits may be configured differently (e.g., with a specific polarization or spin). Further, quantum logic gates (which may also be referred to as a gate or quantum gate) are building blocks of a quantum circuit that operates on one or more qubits. The gates may be configured in a variety of arrangements (e.g., different gate circuits) to provide a desired operation of the qubits. The number of qubits in a quantum environment may also vary.

As quantum computing continues to increase in popularity and become more commonplace, the variety and popularity of quantum computing programs (e.g., grouped instructions) also increases. Given the differences between different quantum environments, operation of a quantum computing program may vary from one quantum computing environment to another. For example, quantum environment A may utilize different qubit technology than quantum environment B, or have a different arrangement of quantum gates, or have other properties (e.g., different services) that may affect operation of a quantum computing program in that quantum environment.

Conventionally, development of quantum computing programs may be performed based on a stock quantum computing environment, using what is available without much thought as to the production environment in which the quantum program is to be deployed. As discussed, however, the performance of the quantum computing program may be adversely impacted due to variations between the development environment and the production environment. Alternatively, a developer may obtain a quantum computing device with hardware that is the same as, or similar to, that of the production environment on which the quantum computing program is to be deployed. Such an approach is cumbersome, requiring the procurement of hardware or manual configuration of software or both, that matches that of the quantum production environment. As such, conventional systems may not provide an efficient or effective solution for developing and testing quantum computing programs.

Aspects of the disclosure address the above-noted issues and other deficiencies by processing logic that may analyze a quantum environment (which may also be referred to as a production environment) to infer one or more properties of that environment. Processing logic may create a quantum isolation zone (QIZ) that resembles or replicates the one or more properties of the quantum environment. That QIZ may serve as a staging environment used to test the quantum computing program in its intended environment. Processing logic may adapt one or more QIZs on a single quantum computing device to support development of quantum computing programs for a variety of different quantum environments. Quantum computing programs may be tested in an efficient and effective manner.

For example, processing logic may analyze the production environment and services that are run on the production environment. Processing logic may analyze the scheduler, the task manager, the qubit registry, or a combination thereof, of the production environment to determine one or more properties of the production environment. Additionally, or alternatively, processing logic may analyze one or more quantum computing programs such as a quantum assembly language file (QASM) that are to be tested, looking to determine or infer one or more qubit requirements of the quantum computing programs. From analyzing the quantum computing program, processing logic may also determine services that the quantum computing program may expect or require to operate as intended, as well as service-to-service relationships (e.g., dependencies) that are expected or preferred for the quantum computing program to perform as intended.

Processing logic may produce a configuration file that captures each of the properties of the production environment and requirements of the quantum computing program. Processing logic may use the configuration file to create a QIZ, with corresponding properties (e.g., the same as or approximating the properties of the production environment). For example, the QIZ may be created with the same operating system services, auxiliary services, and the requisite number of qubits, as determined through analysis of the quantum computing program, the production environment, or both. Processing logic may store this configuration file for repetitive or later use. The configuration file may also be shared with other devices to replicate the production environment for running the same or a different quantum computing program. In some embodiments, processing logic can run some or all of the services in one QIZ. In some embodiments, processing logic may use a graph-based approach to manage parent-child relationships among services. In some embodiments, processing logic may run all services in a cascading manner so that the individual services can be isolated from each other and hence only has access to what that service needs. The production environment may be operationally replicated within a QIZ which can be run repeatedly (e.g., on the same device or on different devices simultaneously) such as for comparison testing or to support multiple test beds.

Processing logic may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a quantum computing device, a combination thereof.

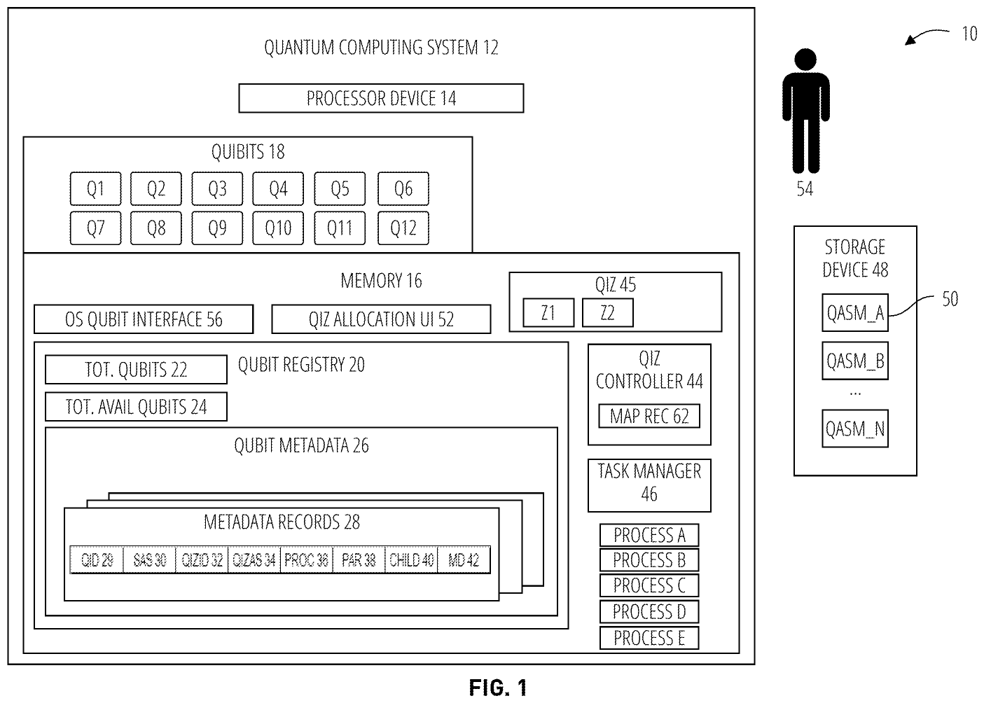

FIG. 1 shows an example of a quantum computing system 12 in accordance with some embodiments. Quantum computing system 12 may support operation of one or more quantum isolation zones (QIZs) 45. The environment 10 includes a quantum computing system 12 that operates in a quantum environment but can operate using classical computing principles or quantum computing principles. When using quantum computing principles, the quantum computing system 12 performs computations that utilize quantum-mechanical phenomena, such as superposition and entanglement. The quantum computing system 12 may operate under certain environmental conditions, such as at or near 0° Kelvin. When using classical computing principles, the quantum computing system 12 utilizes binary digits that have a value of either 1 or 0.

The quantum computing system 12 includes at least one processor device 14 (which may also be referred to as a processing device) and at least one memory 16. The quantum computing system 12 implements one or more qubits 18. In this example, qubits 18 is shown as having twelve qubits (e.g., Q1-Q12), however, quantum computing system 12 may have a different number of qubits, such as hundreds of qubits, thousands of qubits, or more.

The quantum computing system 12 includes a qubit registry 20 that maintains information about the qubits 18, including, for example, a total qubits counter 22 that identifies the total number of qubits 18 implemented by the quantum computing system 12 and a total available qubits counter 24 that maintains count of the total number of qubits 18 that are currently available for allocation.

The QIZ controller 44 may manage the creation of QIZs 45, the allocation of qubits 18 to a respective QIZ and the processes within a respective QIZ. Metadata 26 may maintain mappings between each qubit and each QIZ, or between each qubit and each process, or both. Metadata 26 may also maintain parent-child relationships between processes (e.g., processes A-D), and availability of each qubit within a given QIZ.

For example, the qubit registry 20 may include qubit metadata 26, which comprises a plurality of metadata records 28, each of which maintains up-to-date information about a corresponding one of qubits 18. Each metadata record 28 may include a qubit identifier (QID) 29 that contains an identifier of a respective one of qubits 18. For example, a first record of metadata record 28 may include a QID that uniquely identifies Q1, and a second record of metadata record 28 may include a second QID that uniquely identifies Q2, and so on.

Further, each metadata record 28 may include a system availability status (SAS) 30 that identifies whether the corresponding qubit 18 is available for allocation at the quantum computing system level, a QIZ identifier (QIZID) 32 that identifies the QIZ (e.g., Z1 or Z2), if any, to which the corresponding qubit 18 has been allocated, and a QIZ availability status (QIZAS) 34 that identifies whether the corresponding qubit 18, if allocated to a QIZ 45, is available in the QIZ 45 or has been allocated to a quantum process executing in the QIZ 45.

Each metadata record 28 may further include a process identifier (PROC) 36 of the quantum process, if any, to which the corresponding qubit 18 has been allocated, a parent identifier (PAR) 38 that identifies a parent quantum process, if any, of the quantum process to which the corresponding qubit 18 has been assigned, and a child identifier (CHILD) 40 that identifies a child quantum process, if any, of the quantum process to which the corresponding qubit 18 has been assigned. Each metadata record 28 may also include additional metadata 42 which may not be relevant to the examples disclosed herein. Additional metadata 42 may include metadata that indicates a real-time state of the corresponding qubit 18, such as whether the qubit 18 is in an entangled state, is in superposition, or the like.

Initially, qubits 18 may be unallocated, and thus, the system availability status 30 for each metadata record 28 may have an initial value of “A” indicating that the corresponding qubit 18 is available. The values of the other fields in the metadata records 28 may have a “NULL”, which can comprise any value that indicates that the field is empty. The quantum computing system 12 may include a QIZ controller 44 that establishes QIZs (e.g., Z1 or Z2) in which one or more quantum processes execute within. QIZ controller 44 may allocate one or more of the qubits 18 to each QIZ 45. In some embodiments, the allocation of qubits to one QIZ may not or may never overlap with that of other QIZs. In such a case, Z1 and Z2 must be allocated different qubits in a non-sharing manner. As such, a quantum process operating in a first one of QIZ 45 may not have access to qubits that are dedicated to a second one of QIZ 45.

The quantum computing system 12 may include a task manager 46 that is configured to initiate a quantum process from a quantum program file 50, such as a quantum assembly language (QASM) file, or the like. In some examples, a storage device 48 may contain a plurality of quantum program files 50 (e.g., QASM files A-N), each of which includes quantum programming instructions that, when executed, implement a desired functionality.

The quantum computing system 12 may include a QIZ allocation user interface (UI) 52 that allows an operator 54 to interact with the QIZ controller 44 to create or modify one or more QIZs 45. The quantum computing system 12 may also include an operating system (OS) qubit interface 56 that is invoked when a quantum process attempts to read, write, or otherwise query a qubit 18. In response, the OS qubit interface 56 may communicate with the QIZ controller 44, or, in other implementations, the QIZ controller 44 may be integrated with the OS qubit interface 56.

The QIZ controller 44 may receive a request from a requestor to allocate a first group of qubits 18 that are available to a first QIZ (e.g., Z1). The QIZ may be established such any quantum process associated with (e.g., operating within) the first QIZ is limited to accessing only those qubits allocated to the first QIZ. The request may identify the number of qubits 18 and, if applicable, other criteria, such as a particular type of qubit, or any other desired characteristics of the qubits 18.

In some examples, the requestor may be the QIZ allocation UI 52 which makes the request in response to input from the operator 54. Additionally, or alternatively, the requestor may be a programmatic request from a process executing on the quantum computing system 12 or elsewhere. The request may contain instructions to allocate one or more of qubits 18 to a new or existing one of QIZs 45. The request may come directly to the QIZ controller 44, or indirectly via the OS qubit interface 56.

The QIZ controller 44 may handle a request, allocate one or more qubits to the QIZ (as specified by the request), and update registry 20 and metadata records 28 accordingly. For example, assume that the request indicates that six of qubits 18 are to be allocated to a first QIZ. The QIZ controller 44 may access the qubit metadata 26 and identify six qubits 18 that have a system availability status 30 that indicates the qubits 18 are available. In this example, the QIZ controller 44 may determine that the six qubits Q1-Q6 are available based on the system availability status 30 of each of the corresponding metadata records 28. The QIZ controller 44 may modify the system availability status 30 of the corresponding metadata records 28 with a value of “NA” (not available) to indicate that the six qubits Q1-Q6 are no longer available for allocation. The QIZ controller 44 may obtain a unique QIZ identifier, (e.g., corresponding to Z1), and modify the QIZ ID 32 of each corresponding metadata record to indicate that the Q1-Q6 are allocated to the QIZ Z1. The QIZ controller 44 may generate the unique QIZ ID or be provided the unique QIZ ID by the requestor or some other mechanism. The QIZ controller 44 may modify the QIZ availability status 34 to indicate that the qubits Q1-Q6 are available for allocation within the QIZ Z1. The QIZ controller 44 may modify the total available qubits counter 24 to indicate that six of qubits 18 (e.g., Q1-Q6)) are now available for allocation to a QIZ.

Further, the task manager 46 may receive a request to initiate a quantum process (e.g., process A) into the QIZ Z1. The process (e.g., process A) may be initiated based on an instruction, dependency, or other indication of process A that may be present in program files 50 (e.g., as indicated by QASM_A). The request may be contained in a schedule, may be received programmatically, or may be initiated via input from the operator 54. The task manager 46 may access and parse QASM_A to determine that, during execution, a quantum process initiated from the QASM_A will utilize two of qubits 18. In other implementations, the number of qubits 18 to be allocated to the quantum process (e.g., process A) may be contained in the request to initiate the quantum process. The task manager 46 may send a request to the QIZ controller 44 for an allocation of two of qubits 18 from those which are allocated to QIZ Z1 (e.g., Q1-Q6). The QIZ controller 44 receives the request to allocate two qubits 18 in the QIZ Z1 to a quantum process that is, or will be, associated with the QIZ Z1. Based on the metadata records 28, the QIZ controller 44 may determine that the qubits Q1 and Q2 which are allocated to QIZ Z1 are available for process A. The QIZ controller 44 may modify the QIZ availability status 34 of the metadata records 28 that correspond to Q1 and Q2, to indicate that Q1 and Q2 are allocated to a process (e.g., process A) and thus are no longer available for allocation (e.g., “not available”). The QIZ controller 44 may provide the qubit IDs of the qubits Q1 and Q2 to the task manager 46. The task manager 46 may initiate a quantum process (e.g., process A) within the QIZ Z1 with location/address information of the Q1 and Q2. The task manager 46 may provide a unique program ID (PID) of the quantum process A to the QIZ controller 44. The QIZ controller 44 may maintain a mapping record 62 that maps each quantum process (e.g., via program ID) to its respective QIZ (e.g., mapping process A to Z1). The quantum process A is now said to “execute in” or be “associated with” the QIZ Z1. As a result, the quantum process A may be constrained to access the qubits which are allocated to Z1 (e.g., Q1-Q6), and further constrained to access only Q1 and Q2 as described.

As an example, the quantum process A may issue a request to the OS qubit interface 56 to obtain a list of qubit IDs of all qubits 18 to which the quantum process 60 has access (i.e., read access and/or write access) or which are available for allocation. The OS qubit interface 56 communicates this request with the QIZ controller 44. The QIZ controller 44 determines the PID of the requestor which indicates to the QIZ controller 44 that the request is from process A. The QIZ controller 44 may access the mapping record 62 and determine that the quantum process A is associated with the QIZ Z1. The QIZ controller 44 may access the metadata records 28 and determines that the qubits Q1-Q6 are allocated to the QIZ Z1, and that the four qubits Q3-Q6 are available. Because the qubits Q1 and Q2 have already been allocated to the quantum process A, and the four qubits Q3-Q6 are available, the QIZ controller 44 returns the qubit IDs of the qubits Q1-Q6 to the quantum process A via the OS qubit interface 56, indicating that the quantum process A has access to the qubits Q1 and Q2 and that the qubits Q3-Q6 are available for allocation. Thus, from the perspective of the quantum process A, the quantum computing system 12 contains four available qubits (e.g., Q3-Q6), and the quantum process A is unaware of and unable to access (e.g., is isolated from) the remaining qubits 18.

In response to the information that the qubits Q3-Q6 are available, the quantum process A may issue a request to the OS qubit interface 56 to have an additional qubit 18 allocated to the quantum process 60. The OS qubit interface 56 may provide the request to the QIZ controller 44. The QIZ controller 44 may select one of the qubits Q3-Q6, modify the appropriate metadata record 28 to indicate the qubit 18 is now allocated to the quantum process 60, and return information to the quantum process A that identifies the allocated qubit 18.

Further, the task manager 46 may receive a request to initiate a quantum process (e.g., quantum process B) based on a second QASM file (e.g., QASM_B). The request may indicate that the quantum process B is to reside in QIZ Z1. The task manager 46 may access and parse the QASM_B to determine that, during execution, the quantum process will utilize one qubit 18. In response, the task manager 46 may send a request to the QIZ controller 44 for an allocation of one qubit 18 from among those allocated to QIZ Z1 to process B. The QIZ controller 44 may receive the request to allocate the one qubit in the QIZ Z1 to the quantum process B that is to be associated with QIZ Z1. Based on the metadata records 28, the QIZ controller 44 may determine that the qubit Q3 is available for allocation within the QIZ Z1. Further, the QIZ controller 44 may modify the QIZ availability status 34 of the metadata record 28 that corresponds to Q3, to indicate that the corresponding qubit Q3 has been allocated (to process B) and thus is no longer available for allocation. The QIZ controller 44 may provide the qubit ID of the qubit Q3 to the task manager 46. The task manager 46 may initiate the quantum process B within the QIZ Z1 with location information of the qubit Q3. The task manager 46 may provide a unique PID of the quantum process B to the QIZ controller 44. The QIZ controller 44 may map the QIZ Z1 to the PID of process B in map records 62. As a result, the quantum process B is now said to “execute in” or be “associated with” the QIZ Z1.

A QIZ may have multiple processes associated with it. For example, Z1 may have process A and process B associated with it. In one example, subsequent to the allocation of the qubit Q3 to the quantum process B, the quantum process A issues a request to the OS qubit interface 56 to obtain a list of qubit IDs of all qubits 18 to which the quantum process A has access (i.e., read access and/or write access) and which are available for allocation. The OS qubit interface 56 communicates with the QIZ controller 44. The QIZ controller 44 determines the PID of the requestor to identify the requestor as process A. In response, the QIZ controller 44 may access the mapping record 62 and determines that the quantum process A is associated with the QIZ Z1. The QIZ controller 44 may access the metadata records 28 and determines that the qubits Q1-Q6 have been allocated to the QIZ Z1, the qubit Q3 has been allocated to the quantum process B, and that the three qubits Q4-Q6 are available. Based on the metadata record corresponding to Q3, the QIZ controller 44 may determine that the quantum process B is not related to the quantum process A because the parent identifier 38 and the child identifier 40 are NULL. This may indicate that the quantum process A has no parent process or child process.

Further, the metadata record 28 for Q4 may indicate that the quantum process A is a parent process of a quantum process C. The QIZ controller 44 may modify the child identifier 40 of the metadata records for Q1 and Q2 to indicate that quantum process C is a child process of the quantum process A. Assume further that a quantum process D is initiated from QASM_D into QIZ Z1 and allocated the qubit Q5. The QIZ controller 44 may map the PID of the quantum process D (e.g., through its PID) to QIZ Z1 in mapping records 62. In this example, the quantum process D may be identified as a child process of the quantum process A. The QIZ controller 44 may modify the QIZ availability status 34 of the metadata record 28 that corresponds to Q5, to indicate that the qubit Q5 is no longer available for allocation. The QIZ controller 44 may modify the process identifier 36 of the metadata record 28 for Q5 to indicate that the qubit Q5 is allocated to the quantum process D. The QIZ controller 44 may modify the parent identifier 38 of the metadata record 28 for Q5 to indicate that the quantum process A is a parent process of the quantum process D. The QIZ controller 44 may modify the child identifier 40 of the metadata records 28 for Q1 and Q2 to indicate that the quantum process D is a child process of the quantum process A.

A graph may represent the parent-child relationship between the processes and the qubits that are allocated to those processes. For example, the metadata records 28 for Q1, Q2, Q4, and Q5 may establish a relationship graph that indicates that process A has ownership of Q1 and Q2 and is parent to process C (which owns Q4) and process D (which owns Q5), while process B is neither parent nor child to any of the other processes.

The parent-child relationships of each of the processes may impact the visibility of the quantum processes to each of the qubits. For example, assuming that process A issues a request to the OS qubit interface 56 to obtain a list of qubit IDs of all qubits 18 to which the quantum process A has access (i.e., read access and/or write access) or which are available for allocation. The OS qubit interface 56 communicates this request with the QIZ controller 44. The QIZ controller 44 determines the PID of the requestor, which is the PID of the quantum process A. The QIZ controller 44 accesses the mapping records 62 and determines that the quantum process A is associated with the QIZ Z1. The QIZ controller 44 accesses the metadata records 28 and determines that the qubits Q1-Q6 are allocated to the QIZ Z1, and of those qubits, Q6 is available. The QIZ controller 44 also determines that the Q1 and Q2 are allocated to the quantum process A. The QIZ controller 44 determines (though the metadata records) that the quantum process A has two child processes (process C and process D) executing in the QIZ Z1. Because the quantum processes C and D are child processes of the quantum process A, the quantum process A is given access to the qubits Q4 and Q5 which are allocated to process C and process D, respectively. The QIZ controller 44 returns the qubit IDs of the qubits Q1, Q2, Q4, Q5, and Q6, indicating that the quantum process 60 has access to the qubits Q1, Q2, Q4, and Q5, and that the qubit Q6 is available for allocation.

Assume next that the quantum process C issues a request to the OS qubit interface 56 to obtain a list of qubit IDs of all qubits 18 to which the quantum process C has access (i.e., read access and/or write access) or which are available for allocation. The OS qubit interface 56 communicates with the QIZ controller 44. The QIZ controller 44 may determine that the process C is associated with QIZ1 and access metadata records 28 to determine which qubits are allocated to Z1 and which among those are available. For example, QIZ controller may determine that Q6 is available, and that qubit 18-4 has been allocated to the quantum process 68. The QIZ controller 44 may determine (based on metadata records 28) that the quantum process C has no child processes executing in the QIZ Z1, and that the quantum process A is a parent process of the quantum process C. Because the quantum process A is a parent process of the quantum process C, the quantum process C may be given access to the qubits Q1 and Q2. However, because the quantum process D is neither a parent process nor a child process of the quantum process C, the quantum process C has no visibility to the qubit Q5 which is allocated to the quantum process D.

The QIZ controller 44 may return the qubit IDs of the qubits Q1, Q2, Q4, and Q6, indicating that the quantum process 68 has access to the qubits Q1, Q2, and Q4, and that the qubit Q6 is available for allocation.

Further, additional QIZs may be created, having exclusive access to qubits 18 that are not already allocated to a QIZ. For example, the QIZ controller 44 may receive a request, from a requestor, to allocate a second group of qubits 18 from available qubits 18 to establish a second QIZ Z2. A quantum process that is associated with it Z2 has visibility and access to only the qubits 18 that are allocated to Z2 (e.g., the second group of qubits 18). For example, the request indicates may indicate five qubits 18 are to be allocated to the second QIZ Z2. The QIZ controller 44 may access the qubit metadata 26 and identify five qubits 18 that have a system availability status 30 that indicates the qubits 18 are available. In this example, the QIZ controller 44 determines that the five qubits Q7-Q11 are available based on the system availability status 30 of the corresponding metadata records 28. The QIZ controller 44 may modify the system availability status 30 of those metadata records for Q7-Q11 to indicate that the five qubits Q7-Q11 are no longer available for allocation, like as described with respect to Z1.

For example, the QIZ controller 44 may obtain a unique QIZ identifier, (e.g., “Z2”), and modifies the QIZ ID 32 of the metadata records 28 for Q7-Q11 to indicate that they have been allocated to the QIZ Z2. The QIZ controller 44 may modify the QIZ availability status 34 of each of those metadata records to indicate that those qubits Q7-Q11 are available for allocation (to a process) within the QIZ Z2. The QIZ controller 44 modifies the total available qubits counter 24 to indicate that one qubit 18 (i.e., qubit Q12) is now available for allocation to a QIZ. Additional quantum processes such as process E may be initiated within Z2 based on program instructions 50, with processes like those described with respect to Z1.

It is noted that each component of the quantum computing system 12 such as QIZ controller 44, task manager 46, processes A-E, interface 56, UI 52, or other components, may be performed by or attributed to the quantum computing system 12, or to processor device 14, or both.

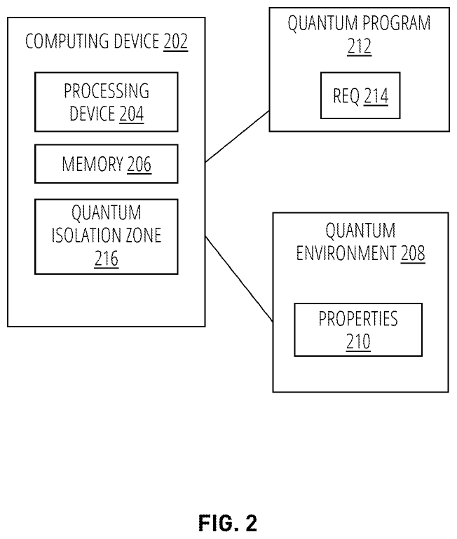

FIG. 2 shows a block diagram of an example computing device that may use a quantum isolation zone for staging of a quantum program, in accordance with some embodiments. Computing device 202 includes a processing device 204 and a memory 206. Memory 206 may include volatile memory devices (e.g., random access memory (RAM)), non-volatile memory devices (e.g., flash memory) and/or other types of memory devices. Computing device 202 may include processing logic such as processing device 204. Computing device 202, or quantum environment 208, or both, may correspond to a quantum computing system 12 of FIG. 1. Similarly, processing device 204 may correspond to processor device 14 of FIG. 1.

Processing device 204 may analyze the quantum environment 208 to determine one or more properties 210 of the quantum environment 208. The processing device 204 may analyze a quantum program 212 to determine one or more requirements 214 of the quantum program 212. Processing device 204 may generate a quantum isolation zone in view of the one or more properties 210 and the one or more requirements 214, to resemble the quantum environment 208. Processing device 204 may run the quantum program 212 within the QIZ 216 that resembles the quantum environment 208.

In such a manner, processing device 204 may use QIZ 216 as a staging zone, while considering the unique properties 210 of the quantum environment 208 in which the quantum program 212 may be deployed to, while considering the requirements 214 of the quantum program 212. The QIZ 216 may be used to prop up the quantum program 212 and gain confidence in it before deploying the quantum program 212 to the quantum environment 208.

In some embodiments, quantum environment 208 may be integral to computing device 202. In other embodiments, the quantum environment 208 may be a separate quantum computing device from computing device 202. The QIZ 216 may be generated to match or resemble as close as possible the properties 210 of the quantum environment 208. Quantum program 212 may reside local to the computing device 202, or in quantum environment 208, or on a remote device.

As described with respect to FIG. 1, QIZ 216 may have one or more qubits allocated to it that may limit access to those qubits from processes outside of the QIZ 216. Further, the QIZ 216 may have one or more processes associated to the QIZ that may share resources (e.g., qubits) of that QIZ.

Analyzing the quantum program 212 may include parsing one or more quantum assembly language (QASM) files of the quantum program 212 to determine the one or more requirements of the quantum program 212. For example, a quantum program 212 may comprise one or more QASM files. Processing device 204 may parse the QASM files (e.g., line by line) to determine qubit specific information such as a number (e.g., how many) of one or more qubits are required by the quantum program 212, or how a qubit is to spin, or a qubit polarization, or a gate circuit arrangement that is to be applied to the one or more qubits, or a type of qubit (e.g., superconducting qubits, trapped ion qubits, semiconductor quantum dots, photonic qubits, etc.).

Additionally, processing device 204 may parse the quantum program 212 to determine or infer other requirements such as if the program utilizes an error correction software, or indicates a heat threshold, a heat profile, or a noise tolerance. In some embodiments, processing device 204 may parse the quantum program 212 to infer whether the quantum program 212 requires or relies upon another. For example, instructions in the quantum program 212 may indicate a reliance or a requirement to interface with a service (that is not part of quantum program 212) such as a registry service, a scheduler service, or a task manager service. As such, processing device 204 may analyze the quantum program 212 to determine service-based relationships of the quantum program 212, or physical characteristics of qubits that may be required or relied upon by the quantum program 212, or both.

In some embodiments, processing device 204 may analyze the quantum environment 208 by observing operation of the scheduler, or the task manager, or the qubit registry of the quantum environment 208, or a combination thereof. Based on such observation, processing device 204 may determine the one or more properties 210 of the quantum environment 208. For example, based on such observation, processing device 204 may infer a total number of one or more qubits in the quantum environment 208, a type of the one or more qubits in the quantum environment 208, or one or more services operating in the quantum environment, or other properties of the quantum environment 208. The properties 210 may include physical properties, configuration of software, or both. Processing device 204 may generate the quantum isolation zone 216 in view of the one or more properties 210. For example, processing device 204 may generate the QIZ 216 to resemble or replicate the one or more properties of the quantum environment 208. The QIZ may be generated with the same physical properties (e.g., number of qubits, type of qubits, spin, etc.) or have the same software configuration (e.g., with the same services being operational), or both, as that of the quantum environment 208.

In response to the running of the quantum program 212 satisfying one or more criteria, processing device 204 may deploy the quantum program 212 to the quantum environment 208. For example, processing device 204 may run one or more test cases on the quantum program 212 and monitor outputs (e.g., values or parameters), speed, performance, program state, system temperature, or other behavior against expected results to determine whether the one or more criteria are satisfied. A test case and criteria may be determined by a user such as a developer or tester of the quantum program 212. In response to the one or more criteria not being satisfied, the quantum program may not be deployed.

Deploying the quantum program 212 to the quantum environment 208 may include exporting a configuration of the quantum isolation zone to the quantum environment and exporting the quantum program to run in the quantum environment. The configuration may include the one or more properties 210 of the quantum environment or the one or more requirements 214 of the quantum program. If the configuration of the QIZ differs from the properties 210, then the configuration may include the properties of the QIZ that the quantum program 212 tested in. The quantum program may include the quantum executable instructions (e.g., the QASM files) of the quantum program 212.

In some examples, processing device 204 may generate multiple QIZs in view of the one or more properties 210 and the one or more requirements 214, to replicate the quantum environment 208 with multiple QIZs. Processing device 204 may run the quantum program 212 within each of the multiple QIZs. They may be run against the same or different test cases. They may also be run in parallel. Processing device 204 may perform each of the described operations automatically (e.g., without intervention or input of a human).

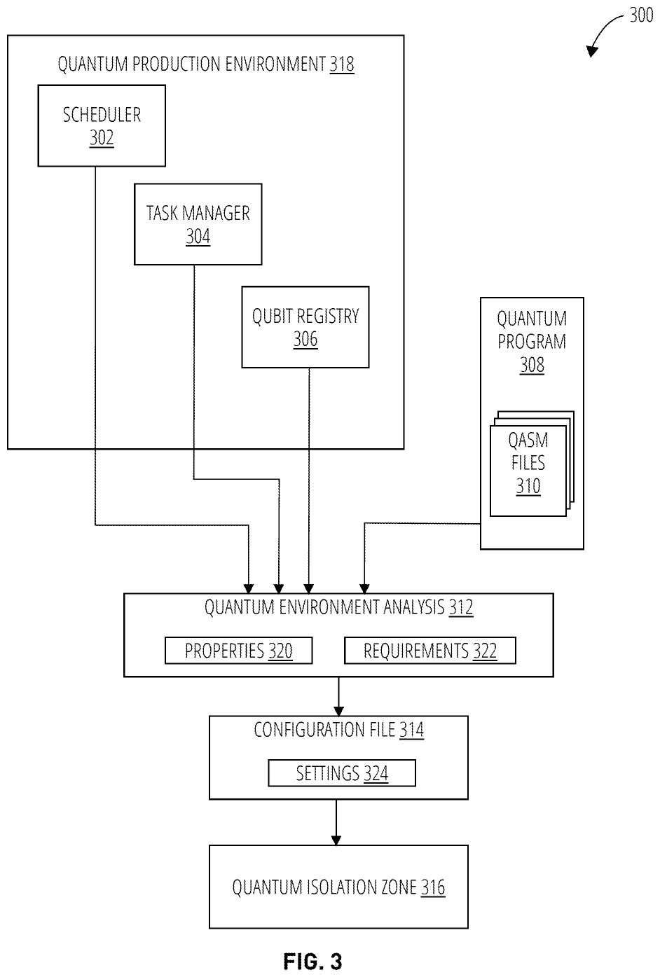

FIG. 3 illustrates an example workflow 300 for testing of a quantum program 308, in accordance with some embodiments. The workflow 300 may be performed by processing logic or a processing device that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

Workflow 300 shows creation of a quantum isolation zone 316 that may be used to stage testing of a quantum program 308. Quantum program 308 may include one or more QASM files 310 which include instructions that may be executed by a quantum computing device.

A quantum production environment 318 may include a scheduler 302, a task manager 304, a qubit registry 306, or a combination thereof, or other OS or auxiliary services. The qubit registry 306 may be used to represent and manage operation of qubits. As described in other sections, the qubit registry 306 may describe how many qubits are in the quantum production environment 318 (e.g., total qubits 22), how many are available (e.g., total available qubits 24), qubit allocation metadata (e.g., metadata records 28), or a combination thereof. The qubit registry 306 serves as the central control point where qubits can be allocated or made available.

Task manager 304 may manage operation of tasks or processes (e.g., starting a task, ending a task, pausing a task, or resuming a task). The task manager 304 may manage the processes and states of the processes within the quantum production environment 318. The scheduler 302 may schedule upcoming jobs, (e.g., when a job should start). A job may include one or more processes.

At quantum environment analysis 312, processing logic may analyze the quantum production environment 318 to determine one or more properties 320 of the quantum production environment 318. For example, processing logic may analyze the scheduler 302, the task manager 304, the qubit registry 306, or a combination thereof to determine the properties of quantum production environment 318. Processing logic may analyze the production environment 318 for other properties such as electromagnetic noise, thermal energy (e.g., heat), and error correction algorithms (e.g., services) running in the production environment, or other physical or software configuration properties.

Further, processing logic may parse the quantum program 308 to infer quantum program requirements 322 such as, for example, service-based relationships or physical characteristics of qubits. At quantum environment analysis 312, processing logic may parse the quantum program 308 (e.g., QASM files 310) to infer the qubits expected by the quantum program 308, as well as modifications that are expected for the qubits to operate properly such as how to make them spin, their polarization, or gates to put the qubits through. In some embodiments, the quantum program 308 may be parsed to infer the qubit types (e.g., superconducting qubits, trapped ion qubits, semiconductor quantum dots, photonic qubits, etc.) which may be preferred or expected by quantum program 308.

The quantum program 308 may also be parsed to infer or determine what error correction software is expected by the quantum program 308, what heat tolerances the quantum program 308 has, what heat profile the quantum program 308 might generate when running, a noise tolerance of the quantum program 308, services that the quantum program 308 relies on to be successful, or a combination thereof. In some cases, quantum environment analysis 312 may determine a service chain that defines one or more service-to-service dependencies that the quantum program 308. For example, a quantum program 308 may have a requirement to interface with one or more services such as a registry service, the scheduler 302, or the task manager 304. Further, processing logic may determine or infer process dependencies (e.g., parent-child relationships) of one or more processes of the quantum program 308. The dependencies between the one or more processes may define or constrain qubit access to those processes of the quantum program 308, and that qubit access may be enforced within the QIZ 316 once generated, as describe with respect to FIG. 1.

Processing logic may generate a configuration file 314 in view of the one or more properties 320 of the quantum production environment 318 and the requirements 322 of the quantum program 308. The configuration file 314 may include settings 324 that describes the boundaries with which processing logic may use to create QIZ 316. The settings 324 may memorialize or be the same as the one or more properties 320 and requirements 322 which are established through quantum environment analysis 312. In some examples, the settings may include primary OS level services, auxiliary services, error correction software, qubit allocation such services, gate configuration, qubit type, thermal conditions, noise conditions, that match or most closely resemble the properties 320 and requirements 322.

Processing logic may generate QIZ 316 using the configuration file 314. The QIZ 316 may be generated to resemble or replicate the properties 320 of the production environment as close as possible, with the resources available in the staging environment, while satisfying the requirements 322 of the quantum program 308. For example, processing logic may instantiate the QIZ 316 according to properties 320, configure the QIZ according with required services (indicated in requirements 322). Processing logic may allocate ‘X’ qubits to the QIZ to simulate the total number of qubits of the quantum production environment 318, and allocate ‘Y’ qubits to the quantum program 308 (or other services that are to run in the QIZ 316 with the program).

Processing logic may initiate the services in the QIZ 316 that are to be tested. Primary and auxiliary processes may be initiated to replicate the quantum production environment 318. Processing logic may log inconsistencies between requirements 322 and properties 320, such as if qubit properties as indicated in properties 320 do not satisfy expected qubit properties as indicated by requirements 322.

Processing logic may run one or more test cases with the quantum program 308 running in the quantum isolation zone 316, and monitor whether the testing of the program satisfies one or more criteria. If the one or more criteria are satisfied, processing logic may deploy quantum program 308 to a quantum production environment such as quantum production environment 318 or a different environment that matches or resembles environment 318.

In some examples, processing logic may export the configuration file 314 which describes the required services, qubit configuration, noise, thermal thresholds, and other settings, to the quantum production environment 318 or a different production environment, where the QIZ 316 may be instantiated to effectively configure the production environment for this quantum program 308.

Multiple QIZs 316 may be generated with configuration file 314 to test quantum program 308 (e.g., in parallel). The quantum program 308 may be tested in a flexible manner that adjusts a staging zone (the QIZ) to reflect properties 320 of a quantum production environment 318, and in an efficient manner, by creating multiple staging zones for parallel testing.

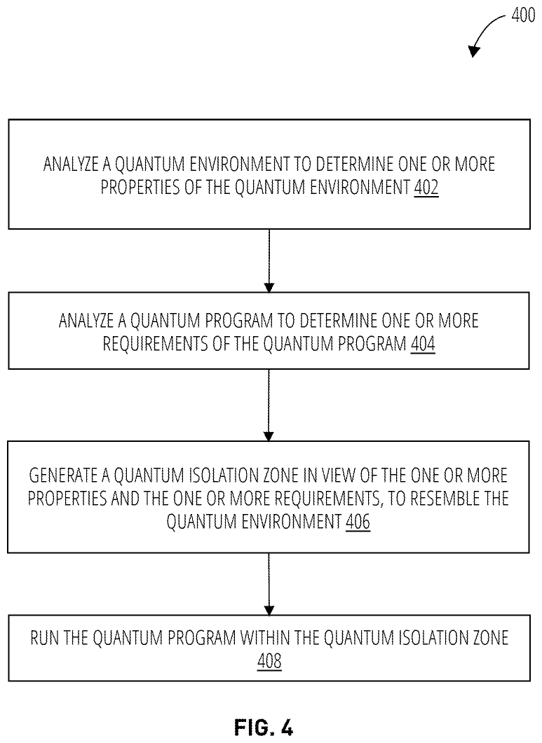

FIG. 4 illustrates an example method for testing of a quantum program with a quantum isolation zone, in accordance with some embodiments. The method may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

With reference to FIG. 4, method 400 illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in method 400 may be performed in an order different than presented, and that not all of the blocks in the method may be performed.

At block 402, processing logic may analyze a quantum environment to determine one or more properties of the quantum environment. Processing logic may observe processes of the quantum environment such as a scheduler, a task manager, a qubit registry, or other services, through an API or other communication interface. From this observation, processing logic may determine or infer a total number of one or more qubits of the quantum environment, a type of the one or more qubits of the quantum environment, or one or more services operating in the quantum environment. For example, processing logic may observe what services are present on the quantum production environment based on observing which services are scheduled by the scheduler or which services that are started or stopped by the task manager. Processing logic may determine the total qubits or total available qubits or both, by observing the qubit registry of the quantum production environment.

At block 404, processing logic may analyze a quantum program to determine one or more requirements of the quantum program. Processing logic may parse the quantum program (e.g., one or more quantum assembly language files of the quantum program) to determine a number of one or more required qubits, a qubit spin, a qubit polarization, a gate circuit, a type of qubit, an error correction software, a heat threshold, a heat profile, a noise tolerance, a required service, or a combination thereof. Processing logic may read the quantum program to determine those requirements that are expressly stated or implied (e.g., through inference) in the quantum program.

At block 406, processing logic may generate, by a processing device, a quantum isolation zone in view of the one or more properties and the one or more requirements, to resemble the quantum environment. This may include allocating qubits to the quantum isolation zone, initiating services in the quantum isolation zone, and otherwise configuring the quantum isolation zone to be the same as (or as similar as possible) to the one or more properties of the quantum environment, while satisfying the one or more requirements of the quantum program.

At block 408, processing logic may run the quantum program within the quantum isolation zone. The quantum program may be run as a process or processes that are within or associated with the quantum isolation zone. Processing logic may generate multiple quantum isolation zones, each having its own resources (e.g., allocated qubits, services, noise and thermal requirements, etc.). The quantum program may be initiated in each of the multiple quantum isolation zones and each instance of the program in its respective quantum isolation zone may have access to only the resources of that quantum isolation zone.

In some examples, if testing of the quantum program satisfies one or more criterion, the quantum program may be deployed. If testing does not satisfy the one or more criterion, the quantum program may not be deployed. In some examples, some or all of method 400 may be performed automatically (e.g., without human input).

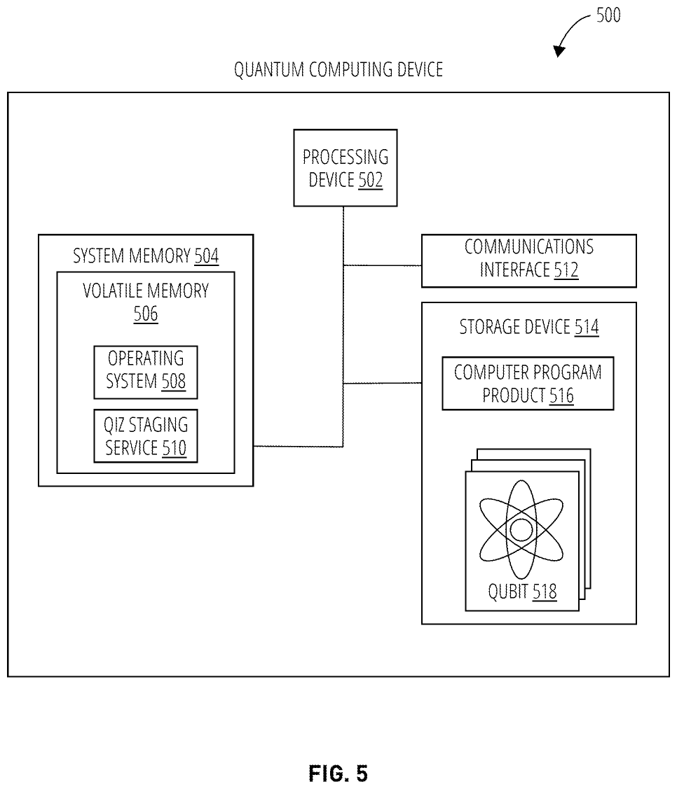

FIG. 5 is a block diagram of an example computing device 500 that may perform one or more of the operations described herein, in accordance with some embodiments. For example, the computing device 500 may create a QIZ based on a quantum program and a quantum environment and use the QIZ to test the quantum program. Computing device 500 may correspond to a quantum computing device or a quantum environment, as described.

Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The computing device 500 may comprise any suitable quantum computing device or devices. The computing device 500 can operate using classical computing principles or quantum computing principles. When using quantum computing principles, the quantum computing device 500 performs computations that utilize quantum mechanical phenomena, such as superposition and entanglement. The quantum computing device 500 may operate under certain environmental conditions, such as at or near zero degrees (0°) Kelvin. When using classical computing principles, the quantum computing device 500 utilizes binary digits that have a value of either zero (0) or one (1). The quantum computing device 500 includes a processing device 502 and a system memory 504. The processing device 502 can be any commercially available or proprietary processor suitable for operating in a quantum environment.

Processing device 502 may be provided by one or more general-purpose processing devices such as a microprocessor, central processing unit, or the like. In an illustrative example, processing device 502 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also comprise one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

The system memory 504 may include volatile memory 506 (e.g., random-access memory (RAM)). The quantum computing device 500 may further include or be coupled to a non-transitory computer-readable medium or non-volatile memory such as a storage device 514. The storage device 514 and other drives associated with computer-readable media and computer-usable media may provide nonvolatile storage of data, data structures, computer-executable instructions, and the like.

The storage device may also provide functionality for storing one or more qubits 518. A number of modules can be stored in the storage device 514 and in the volatile memory 506, including an operating system 508 and one or more modules, such as a QIZ staging service 510. QIZ staging service 510 may perform any of the operations described, such as those of method 400.

Similarly, all or a portion of the examples (e.g., the QIZ staging service 510) may be implemented as a computer program product 516 stored on a transitory or non-transitory computer-usable or computer-readable medium, such as the storage device 514, which includes complex programming instructions, such as complex computer-readable program code, to cause the processing device 502 to carry out the steps described herein. Thus, the computer-readable program code can comprise computer-executable instructions for implementing the functionality of the examples described herein when executed on the processing device 502.

Computing device 500 may further include a network interface device such as communications interface 512, which may communicate with a network which may include other quantum computing systems or classical computing devices. The computing device 500 also may include a video display unit (e.g., a liquid crystal display (LCD) or a cathode ray tube (CRT)), an alphanumeric input device (e.g., a keyboard), a cursor control device (e.g., a mouse) and an acoustic signal generation device (e.g., a speaker). In one embodiment, video display unit, alphanumeric input device, and cursor control device may be combined into a single component or device (e.g., an LCD touch screen).

Unless specifically stated otherwise, terms such as “sending”, “storing”, “obtaining”, “determining”, “analyzing”, “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component may be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 110, sixth paragraph, for that unit/circuit/component. Additionally, “configured to” or “configurable to” may include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
analyzing a quantum environment to determine one or more properties of the quantum environment;
analyzing a quantum program to determine one or more requirements of the quantum program;
generating, by a processing device, a quantum isolation zone in view of the one or more properties and the one or more requirements, to resemble the quantum environment; and
running the quantum program within the quantum isolation zone.

2. The method of claim 1, wherein analyzing the quantum program includes parsing one or more quantum assembly language files of the quantum program to determine the one or more requirements of the quantum program.

3. The method of claim 1, wherein the one or more requirements of the quantum program includes at least one of: a number of one or more required qubits, a qubit spin, a qubit polarization, a gate circuit, a type of qubit, an error correction software, a heat threshold, a heat profile, a noise tolerance, or a required service.

4. The method of claim 1, wherein the one or more properties of the quantum environment includes at least one of: a total number of one or more qubits, a type of the one or more qubits, or one or more services operating in the quantum environment.

5. The method of claim 1, further comprising, in response to the running of the quantum program satisfying one or more criteria, deploying the quantum program to the quantum environment.

6. The method of claim 5, wherein deploying the quantum program to the quantum environment includes exporting a configuration of the quantum isolation zone to the quantum environment and exporting the quantum program to run in the quantum environment, which includes at least one of: the one or more properties of the quantum environment, or the one or more requirements of the quantum program.

7. The method of claim 6, wherein the quantum program is not deployed to the quantum environment in response to the quantum program not satisfying the one or more criteria.

8. The method of claim 1, further comprising: generating one or more second quantum isolation zones in view of the one or more properties and the one or more requirements, to resemble the quantum environment; and running the quantum program within the one or more second quantum isolation zones.

9. A system comprising:
a memory; and
a processing device operatively coupled to the memory, the processing device to:
analyze a quantum environment to determine one or more properties of the quantum environment;
analyze a quantum program to determine one or more requirements of the quantum program;
generate, by the processing device, a quantum isolation zone in view of the one or more properties and the one or more requirements, to resemble the quantum environment; and
run the quantum program within the quantum isolation zone.

10. The system of claim 9, wherein to analyze the quantum program includes to parse one or more quantum assembly language files of the quantum program to determine the one or more requirements of the quantum program.

11. The system of claim 9, wherein the one or more requirements of the quantum program includes at least one of: a number of one or more required qubits, a qubit spin, a qubit polarization, a gate circuit, a type of qubit, an error correction software, a heat threshold, a heat profile, a noise tolerance, or a required service.

12. The system of claim 9, wherein the one or more properties of the quantum environment includes at least one of: a total number of one or more qubits, a type of the one or more qubits, or one or more services operating in the quantum environment.

13. The system of claim 9, wherein the processing device is further to, in response to the running of the quantum program satisfying one or more criteria, deploy the quantum program to the quantum environment.

14. The system of claim 13, where in to deploy the quantum program to the quantum environment includes to export a configuration of the quantum isolation zone to the quantum environment and to export the quantum program to run in the quantum environment, the configuration including at least one of: the one or more properties of the quantum environment, or the one or more requirements of the quantum program.

15. The system of claim 14, wherein the quantum program is not deployed to the quantum environment in response to the quantum program not satisfying the one or more criteria.

16. The system of claim 9, wherein the processing device is further to generate one or more second quantum isolation zones in view of the one or more properties and the one or more requirements, to resemble the quantum environment with the one or more second quantum isolation zones; and to run the quantum program within the one or more second quantum isolation zones.

17. A non-transitory computer-readable storage medium including instructions that, when executed by a processing device, cause the processing device to:
analyze a quantum environment to determine one or more properties of the quantum environment;
analyze a quantum program to determine one or more requirements of the quantum program;
generate, by a processing device, a quantum isolation zone in view of the one or more properties and the one or more requirements, to resemble the quantum environment; and
run the quantum program within the quantum isolation zone.

18. The non-transitory computer-readable storage medium of claim 17, wherein to analyze the quantum program includes to parse one or more quantum assembly language files of the quantum program to determine the one or more requirements of the quantum program.

19. The non-transitory computer-readable storage medium of claim 17, wherein the one or more requirements of the quantum program includes at least one of: a number of one or more required qubits, a qubit spin, a qubit polarization, a gate circuit, a type of qubit, an error correction software, a heat threshold, a heat profile, a noise tolerance, or a required service.

20. The non-transitory computer-readable storage medium of claim 17, wherein the one or more properties of the quantum environment includes at least one of: a total number of one or more qubits, a type of the one or more qubits, or one or more services operating in the quantum environment.
